(19) United States
(12) Patent Application Publication
(10) Pub. No.: US 2002/0109116 A1
(43) Pub. Date: Aug. 15, 2002

(54) Bulk container valve

(76) Inventor: Michael D. Stolzman, Lake Forest, IL (US)

Correspondence Address: F. William McLaughlin, Wood, Phillips, VanSanten, Clark & Mortimer, 500 West Madison Street, Suite 3800, Chicago, IL, 60661-2511, US

(21) Appl. No.: 09/781,854

(22) Filed: Feb. 12, 2001

(51) Int. Cl. F16K 51/00

(52) U.S. Cl. 251/144

(57) ABSTRACT

A bulk container valve is adapted for use with a bulk container having a tubular spout. A plastic housing has an interior chamber connecting a front port to a rear port. The housing is connected to a rear fitting about the rear port for connection to the spout, in use. The rear fitting comprises a cylindrical neck having an annular flange. A valve element is rotationally supported in the interior chamber for movement between a valve open position and a valve closed position. A handle is operatively mated with the valve element for selective rotation of the valve element. A one-piece, all plastic collar is received on the rear fitting. The collar comprises a tubular body including an inner threaded wall for threading on the spout and an end wall having a through opening. The through opening is larger than the neck and smaller then the flange whereby the end wall is captured between the plastic housing and the flange.

### FIELD OF THE INVENTION

This invention relates to intermediate bulk storage containers and, more particularly, to an improved bulk container valve for use therewith.

### BACKGROUND OF THE INVENTION

For shipment of bulk goods, a storage system known as an intermediate bulk container (IBC) has found wide acceptance. In one form, the IBC comprises a 275 gallon container mounted to a skid or pallet. A wire mesh cage is also mounted to the skid and surrounds the container on all four sides. The top of the container is generally exposed. Additional pallets or IBCs can then be stacked for shipping or storage.

The IBC is filled at its top by removing a cover providing access to an opening. A bottom spout acts as an outlet for goods stored in the vessel. A bulk container valve is removably secured to the IBC to control removal of goods from the container. Typically, the valve is threaded onto the spout. A hose can then be connected to the valve with a cam lever coupling to empty the contents of the IBC.

A typical IBC valve comprises a ball valve or cylindrical valve with a valve element contained within a housing. Recently, such IBC valves have used plastic housings and valve elements. This is due to customer's desires to minimize use of wood and metal in all components of the IBC. Metal can be a problem because it conducts electricity and can produce sparks. However, prior IBC valves continue to use metal in certain parts, such as in a threaded collar connected to a rear fitting for threading the valve to the spout.

The present invention is directed to solving one or more of the problems discussed above in a novel and simple manner.

### SUMMARY OF THE INVENTION

In accordance with the invention there is provided a bulk container valve in which the valve collar is of one-piece, plastic construction.

Broadly, there is disclosed herein a bulk container valve adapted for use with a bulk container having a tubular spout. A plastic housing has an interior chamber connecting a front port to a rear port. The housing is connected to a rear fitting about the rear port for connection to the spout, in use. The rear fitting comprises a cylindrical neck having an annular flange. A valve element is rotationally supported in the interior chamber for movement between a valve open position and a valve closed position. A handle is operatively mated with the valve element for selective rotation of the valve element. A one-piece, all plastic collar is received on the rear fitting. The collar comprises a tubular body including an inner threaded wall for threading on the spout and an end wall having a through opening. The through opening is larger than the neck and smaller then the flange whereby the end wall is captured between the plastic housing and the flange.

Further features and advantages of the invention will be readily apparent from the specification and from the drawing.

### BRIEF DESCRIPTION OF THE DRAWING

FIG. 1 is a perspective view of an intermediate bulk container (IBC) including a valve according to the invention;

FIG. 2 is an enlarged, partial perspective view of the valve according to the invention shown connected to a spout of the IBC;

FIG. 3 is a sectional view taken along the line 3-3 of FIG. 2;

FIG. 4 is a front view of a first collar half used to form a collar of the valve of FIG. 2;

FIG. 5 is an inside view of the first collar half of FIG. 4;

FIG. 6 is a front view of a second collar half used to form a collar of the valve of FIG. 2;

FIG. 7 is an inside view of the second collar half of FIG. 6; and

FIG. 8 is a front view of the collar of the valve of FIG. 2.

### DETAILED DESCRIPTION OF THE INVENTION

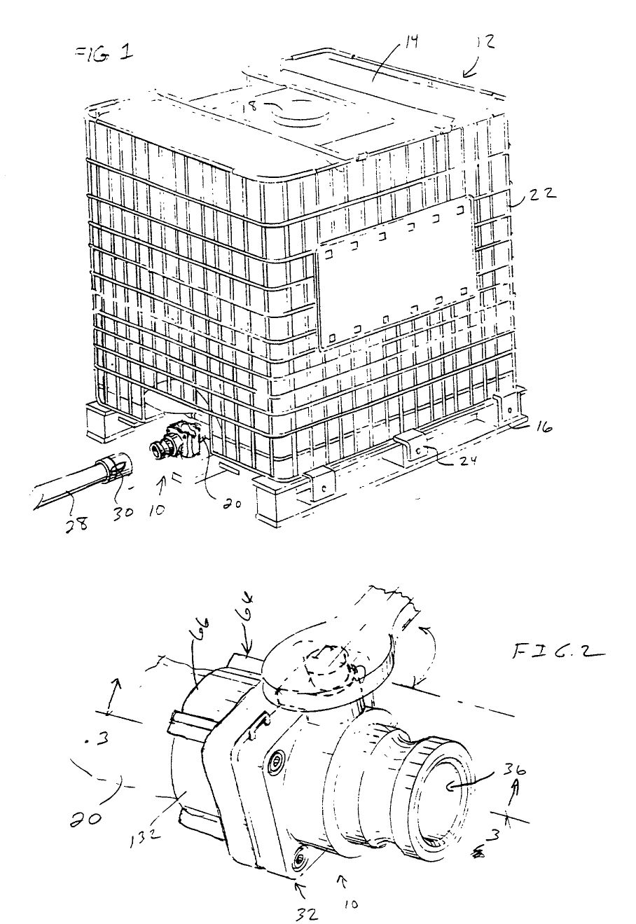

Referring to FIG. 1, a bulk container valve 10 including a one-piece plastic collar according to the invention is illustrated mounted to an intermediate bulk container (IBC) 12. The IBC 12 comprises a 275-gallon plastic vessel 14 resting on a pallet or skid 16. The container 14 can be filled at its top as by removing a cover 18 providing access to an opening (not shown). A bottom spout 20 acts as an outlet for goods stored in the vessel 14. The vessel 14 is surrounded on all four sides by a wire mesh cage 22. The cage 22 is secured to the pallet 16 using brackets 24.

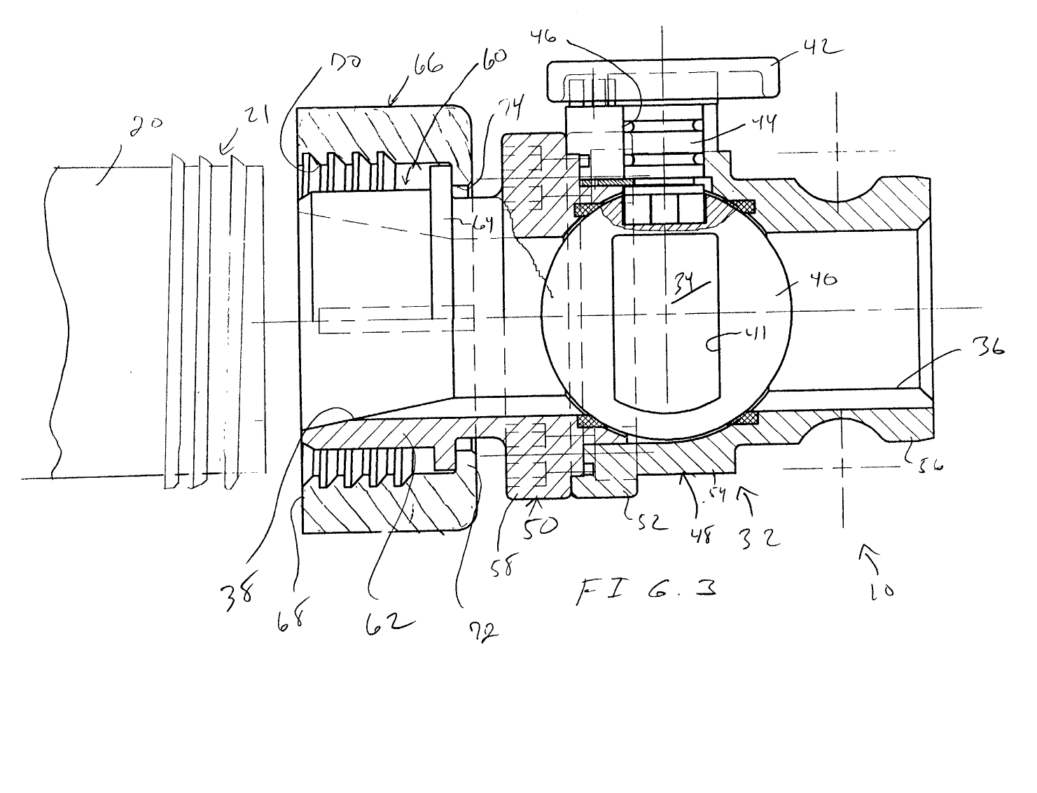

Referring also to FIG. 2, the spout 20 is a tubular spout including an external thread 21, see FIG. 3, as is conventional with IBCs. The spout has a generally circular opening with a diameter of approximately two inches. The valve 10 is adapted to be threadably connected to the spout 20, as described more particularly below. A hose 28 includes a cam level coupling element 30 for securing the hose 28 to the valve 10 in a conventional manner. As described, the valve 10 is selectively operated to empty the contents from the vessel 14 to the hose 20 for ultimate disposition.

In the illustrated embodiment of the invention, the valve 10 comprises a ball valve. However, the one-piece plastic collar could be used with other types of valves, including, for example, cylindrical valves. Moreover, the valve 10 could be used with devices other than an IBC.

With reference to FIGS. 2 and 3, the valve 10 comprises a plastic housing 32 having an interior chamber 34 connecting a front port 36 to a rear port 38. A generally spherical ball valve element 40 is rotationally supported in the interior chamber 34 for movement between a valve open position, not shown, and a valve closed position, see FIG. 3. In the valve open position a through opening 41 in the valve element 40 is aligned with the front port 36 and the rear port 38. In the valve closed position, the valve opening 41 is oriented in a plane perpendicular to a longitudinal axis of the valve 10 so that there is no fluid communication between the front port 36 and the rear port 38. A handle 42 includes an integral stem 44. The stem 44 extends through a transverse housing opening 46 to be operatively mated with the valve element 40 for selective rotation of the valve element 40 between the open and closed positions.

The housing 32 comprises a two-piece plastic housing having a front housing part 48 and a rear housing part 50. For simplicity herein, the longitudinal end of the valve 10 furthest from the IBC 14, in use, is referred to as the front portion, while the opposite end closest to the IBC is referred to as the rear portion. As is apparent, the housing is not limited to the illustrated configuration.

The front housing part 48 includes a front flange 52 connecting a cylindrical wall 54 to a front fitting 56. The flange 52 is generally square-shaped, with the circular wall 54 generally centrally positioned thereon. The rear housing part 50 includes a rear flange 58 of a size and shape corresponding to the front flange 52. The rear flange 58 is connected to a rear fitting 60 about the rear port 38. The rear fitting 78 comprises a rearwardly extending tubular neck 62 adapted to be received in the spout 20, as is well known. The neck 62 includes an annular flange 64 proximate to but spaced from the housing rear flange 58.

A one-piece plastic collar 66 in accordance with the invention is mounted to the rear fitting 60. The collar 66 comprises a tubular body 68 having an inner threaded wall 70. The threaded wall 70 mates with the spout external threads 21. An end wall 72 has a through opening 74. The through opening 74 is larger than the neck 62 and smaller then the annular flange 64 so that the end wall 72 is sandwiched between the annular flange 64 and the rear flange 58 to retain the collar 66 in position on the valve 10, yet permit rotation. In accordance with the invention the collar 66 is formed from two collar halves of molded plastic construction and are fused together using sonic welding.

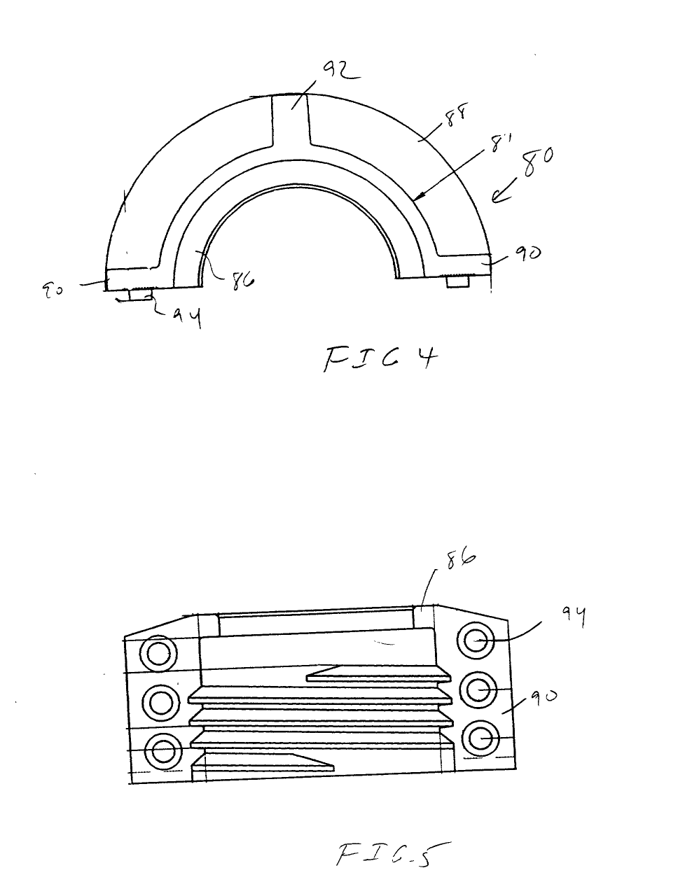

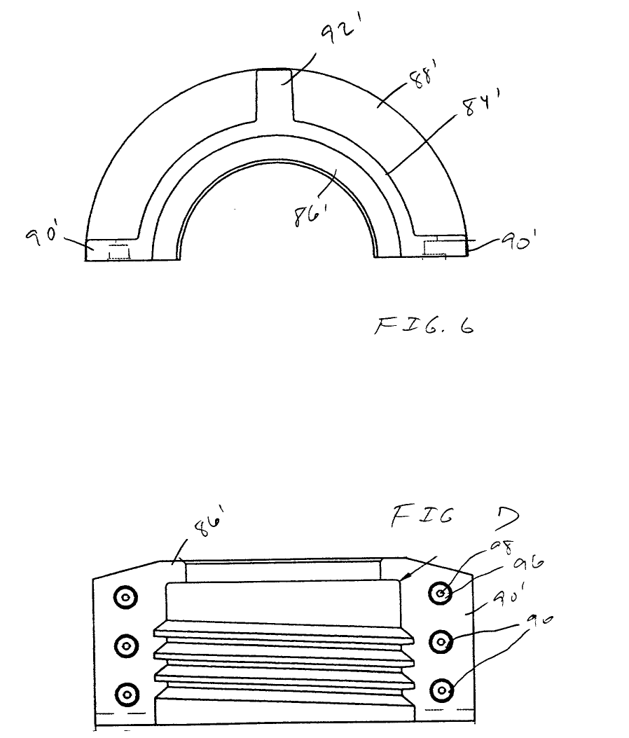

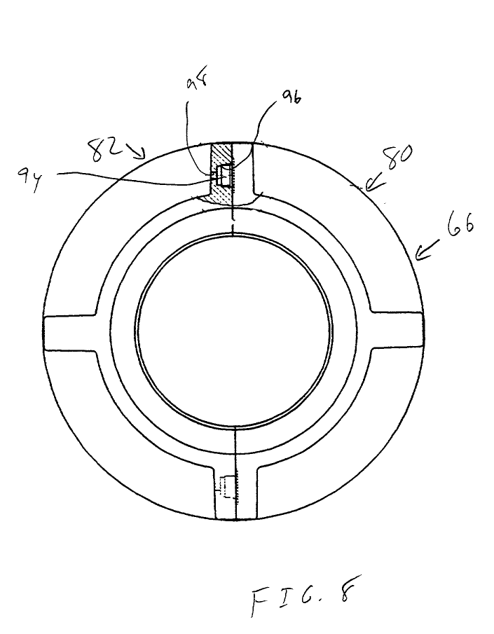

Referring to FIGS. 4-8, the collar 66 comprises a first collar half 80, see FIGS. 4 and 5, and a second collar half 82, see FIGS. 6 and 7. The collar halves 80 and 82 are injection molded of a polycarbonate/polyester blend.

The first collar half 80 comprises a semicylindrical wall 84 connecting a semi-arcuate end wall 86 to a semi-arcuate flange 88. End fins 90 extend radially outwardly from the wall 84 at its opposite ends. A central fin 92 extends radially outwardly from the wall 84 intermediate the end fins 90. Three nipples 94 extend tangentially, relative to the wall 84, from each of the end fins 90.

The second collar half 82 similarly comprises a semicylindrical wall 84′ connecting a semi-arcuate end wall 86′ to a semi-arcuate flange 88′. End fins 90′ extend radially outwardly from the wall 84′ at its opposite ends. A central fin 92′ extends radially outwardly from the wall 84′ intermediate the end fins 90′. The second collar half 82 differs in that it has three counterbores 96 in each of the end fins 90′. The counterbores 96 are sized to receive the nipples 94 of the first collar half 80, as shown in FIG. 8, with the end fins 90 and 90′ in engagement with one another. The counterbores 96 have greater depth than height of the nipples 94. A through bore 98 extends through each counterbore 96.

During manufacturing, the collar halves 80 and 82 are assembled together, as shown in FIG. 8, about the rear fitting 60, as shown in FIG. 3. This assembly is placed in a fixture that vibrates the collar halves 80 and 82 at a high frequency to fuse the collar halves as by sonic welding to produce the one-piece collar 66. As a result, the collar 66 becomes an integral component of the valve 10 and the collar 66 uses no metal parts. The melted plastic during fusing can fill the counterbore 96 as necessary and even the through bore 98. The collar 66 can then be threaded to the spout 20 in the conventional manner using the end fins 90, 90′ that are fused and the central fins 92 and 92′ to aid in turning the collar 66. While the collar 66 is formed using sonic welding, other methods may also be used to fuse the collar halves in to an integral, one-piece unit.

Thus, the bulk container valve 10 provides substantial improvements over the prior art bulk container valves, by minimizing or eliminating use of metal.

I claim:

1. In a bulk container valve adapted for use with a bulk container and having a plastic housing having an interior chamber connecting a front port to a rear port, the housing including a rear fitting about the rear port for connection to a bulk container spout, in use, the rear fitting comprising a cylindrical neck having an annular flange, the improvement comprising:
a one-piece, all plastic collar received on the rear fitting, the collar comprising a tubular body including an inner threaded wall for threading on the spout and an end wall having a through opening, the through opening being larger than the neck and smaller then the flange whereby the end wall is captured between the plastic housing and the flange.

2. The bulk container valve of claim 1 wherein the collar is formed of a fortified polycarbonate material.

3. The bulk container valve of claim 2 wherein the collar is formed of a polycarbonate and polyester blend material.

4. The bulk container valve of claim 1 wherein the collar is formed of an injection molded plastic.

5. The bulk container valve of claim 1 wherein said housing comprises a twopiece housing having a front housing part and a rear housing part.

6. The bulk container valve of claim 1 wherein said collar comprises a first collar half and a second collar half and the first and second collar halves are integrally fused together to form a one-piece collar.

7. The bulk container valve of claim 6 wherein said collar halves are integrally fused as by sonic welding.

8. The bulk container valve of claim 6 wherein the first and second collar halves have radially outwardly extending end fins to assist in rotating the collar and the first collar half end fins are integrally fused to the second collar half end fins.

9. The bulk container valve of claim 8 and wherein the first collar half fins include nipples received in counterbores in the second collar half fins.

10. A bulk container valve adapted for use with a bulk container having a tubular spout, the valve comprising:
a plastic housing having an interior chamber connecting a front port to a rear port, the housing being connected to a rear fitting about the rear port for connection to the spout, in use, the rear fitting comprising a cylindrical neck having an annular flange;
a valve element rotationally supported in the interior chamber for movement between a valve open position and a valve closed position;
a handle operatively mated with the valve element for selective rotation of the valve element; and
a one-piece, all plastic collar received on the rear fitting, the collar comprising a tubular body including an inner threaded wall for threading on the spout and an end wall having a through opening, the through opening being larger than the neck and smaller then the flange whereby the end wall is captured between the plastic housing and the flange.

11. The bulk container valve of claim 10 wherein the collar is formed of a fortified polycarbonate material.

12. The bulk container valve of claim 10 wherein the collar is formed of a polycarbonate and polyester blend material.

13. The bulk container valve of claim 10 wherein the collar is formed of an injection molded plastic.

14. The bulk container valve of claim 10 wherein said housing comprises a twopiece housing having a front housing part and a rear housing part.

15. The bulk container valve of claim 10 wherein said collar comprises a first collar half and a second collar half and the first and second collar halves are integrally fused together to form a one-piece collar.

16. The bulk container valve of claim 15 wherein said collar halves are integrally fused as by sonic welding.

17. The bulk container valve of claim 15 wherein the first and second collar halves have radially outwardly extending end fins to assist in rotating the collar and the first collar half end fins are integrally fused to the second collar half end fins.

18. The bulk container valve of claim 17 and wherein the first collar half fins include nipples received in counterbores in the second collar half fins.

19. In a valve comprising housing having an interior chamber connecting a front port to a rear port, the housing including a rear fitting about the rear port for connection to a spout, in use, the rear fitting comprising a cylindrical neck having an annular flange, the improvement comprising:
a one-piece, all plastic collar received on the rear fitting, the collar comprising a tubular body including an inner threaded wall for threading on a spout and an end wall having a through opening, the through opening being larger than the neck and smaller then the flange whereby the end wall is captured between the plastic housing and the flange.

20. The valve of claim 19 wherein the collar is formed of a fortified polycarbonate material.

21. The valve of claim 20 wherein the collar is formed of a polycarbonate and polyester blend material.

22. The valve of claim 19 wherein said collar comprises a first collar half and a second collar half and the first and second collar halves are integrally fused together to form a one-piece collar.

23. The valve of claim 22 wherein said collar halves are integrally fused as by sonic welding.

24. The valve of claim 22 wherein the first and second collar halves have radially outwardly extending end fins to assist in rotating the collar and the first collar half end fins are integrally fused to the second collar half end fins.

25. The valve of claim 24 and wherein the first collar half fins include nipples received in counterbores in the second collar half fins.
